(19) United States
(12) Patent Application Publication
(10) Pub. No.: US 2008/0281945 A1
(43) Pub. Date: Nov. 13, 2008

(54) DISTRIBUTED CONTENT SYSTEM AND METHOD

(75) Inventors: Gurminder Gill, Renton, WA (US); Jeff Davis, Kirkland, WA (US)

Correspondence Address: AXIOS LAW GROUP. PLLC, 1525 FOURTH AVENUE, SUITE 800, SEATTLE, WA, 98101, US

(73) Assignee: GOGOMOBILE, INC., Kirkland, WA (US)

(21) Appl. No.: 12/054,336

(22) Filed: Mar. 24, 2008

Related U.S. Application Data
(60) Provisional application No. 60/896,789, filed on Mar. 23, 2007.

(51) Int. Cl. G06F 15/173

(52) U.S. Cl. 709/219; 709/244

(57) ABSTRACT

A distributed content registry for unique content identification is provided herein.

### RELATED APPLICATIONS

This application is a non-provisional patent application claiming the benefit of U.S. Provisional Patent Application No. 60/896,789 entitled DISTRIBUTED CONTENT SYSTEM AND METHOD with the named inventors Gurminder Gill and Jeff Davis filed on Mar. 23, 2007, which is hereby incorporated in its entirety by reference.

### FIELD

The present invention relates to the field of data management and publishing. In particular, this invention relates to a distributed identification registry for use in storing, retrieving, aggregating, and associating identifiers for digital content.

### BACKGROUND

Digital content publishers use disparate methods and systems to track content, sell content, control sale channels, protect content etc. They execute through various channels or resellers, who in turn sell digital content to the consumers. Together, they all form a digital ecosystem. Today, the entire ecosystem is filled with propriety techniques, disparate content management systems, different information schemas, different modes of digital content delivery, different tracking mechanisms and standards, and different protection mechanisms etc. The complexity only increases with the advent of a multitude of devices in the digital marketplace. Devices range from conventional PCs and mobile handsets to the newer smart phones and media centers. Catering of digital content to these multiple different devices exponentially increases the complexities involved in the digital ecosystem, i.e., among the publishers, resellers and consumers. Implementation of various rules and policies may be desired to control and ensure legitimate consumption of digital content. On the other hand, consumers would like to conveniently shift their legitimately purchased content from one device to another.

From a hosting and distribution perspective, publishers may desire to control the actual bits of content. Due to lack of standardization and interoperable systems, they may not be able to do so. Current systems may not give the publishers and resellers the flexibility to host the content. Such dynamic delivery models are desired but may not be supported. In fact, such models add complexities and make it difficult to enforce rules and policies.

Further, there are a huge number of content publishers in the ecosystem. Not all have good content management systems to manage their content. And, they may lack an effective way to sell their content using the power of internet. In most cases involving small publishers, they may not even have a system to manage their content. Thus, there exists a long tail of market, which may not be yet tapped due to lack of a standard digital marketplace which enables effective information exchange.

Due to multitude of content from multiple publishers, often resellers get the same content from multiple publishers leading to duplicate content. This may lead to reduced value for the reseller and may create confusion for the consumers. There may not be a standard way for identifying and tracking content across catalogs.

Often, publishers sell rights country-wise. This leads to different aggregators for different territories. This can lead to confusion for device manufacturers who would like to enable their consumers to purchase content in a standard way. A service may be desired which can aggregate content from all the providers and at the same time, enforce rules and polices pertaining to that particular country.

In this digital ecosystem, there may not be a standard way for communication between publishers and resellers. It may lead to ineffective enforcement of rules and policies between them. In one such scenario, publishers are characterized by having silos of content for sale. These silos exist for each content type. For enabling resellers, either the publisher may give away all his content or may expose application programming interfaces (“APIs”) for doing transactions. The resellers may get stuck with the propriety mechanism for a successful information exchange. If the reseller is an aggregator of content, he may act as a publisher and enable other resellers further down the value chain. Ultimately when the content is sold to end consumer, the content may be fulfilled by the entity which hosts the content. There may not be a way for the publisher to track the content in the value chain and enforce his rules and policies around content consumption in an effective manner.

Consumers want to buy content from any of their connected devices. But, there may not be a standard way by which a consumer can purchase content across devices. Interfaces are confusing and non-standard. There may be a need for standardized user experience for the consumption of digital content across devices.

Another consumer use case can be comparison shopping. Existing reseller applications and systems mostly sell content online at a predefined price. There may not be standard service which can enable consumers to get the best deal on digital content. In the physical goods space, there are existing services which can do the same, e.g., Shopping.com. So, consumers may desire to compare various SKUs from different providers of the same digital content

Another desirable consumer use case is recommendation. Consumers may have a lot of legitimate content on their devices (e.g., mobile handsets, PC, etc.). They would like to recommend the media to their friends and family in an effective manner. For example, they may desire to apprise their friends of the latest content from a provider. Their friends can then buy and consume the recommended content in a legitimate fashion. Capabilities to recommend and interoperate across network carriers, devices, publishers may not exist but may be desired.

Lack of a network of publishers, resellers, consumers may prevent implementation of value added applications like targeted advertising to consumers for digital content. Affiliate networks work only for links around html pages which are fundamentally web pages. Targeted advertising around metadata of digital content may not be feasible.

Two general approaches may be considered: a centralized content registry (which can also be considered a database, a website, a service, storefront, a registrar) and a content metadata network (which can be considered a protocol, distribution system, router, switch).

The Metadata network has an opportunity to address the following:
Current proprietary architectures and competing standards create distribution barriers that inhibit growth and interoperability
Consumers are accessing and using content in new ways and are demanding interoperability across devices, services, applications, systems
It is often difficult for Content Suppliers to track, protect and monetize content through the new media and distribution channels.

A shift in architecture may help to meet growing consumer and Content Supplier demand for flexibility and control. Without such a shift, the industry may be missing out on revenue and growth opportunities because of lack of content interoperability and efficient content control, distribution, and tracking infrastructure.

A distributed metadata network lacks a centralized authority compared to a centralized metadata registry. Thus, a distributed metadata network may take advantage of such efficiencies as economies of scale, efficient marketplace and communication between services, and efficiencies in creation of a single protocol for communicating across various services.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagram illustrating a distributed digital content registry system in accordance with one embodiment.

FIG. 2 is a block diagram of publishing host in accordance with one embodiment.

FIG. 3 is an exemplary diagram of a client device in accordance with one embodiment.

FIG. 4 is a block diagram of publishing host in accordance with one embodiment.

FIGS. 5a-b illustrate various Universal Digital Code (“UDC”) formats in accordance with various embodiments

FIG. 6 is a diagram illustrating the actions taken by devices in a distributed content registry system for registering metadata and delivering content in accordance with one embodiment.

FIG. 7 is a flowchart illustrating a process for receiving a UDC registration in a distributed digital content registry system and servicing a UDC request in accordance with one embodiment.

FIG. 8 is a flowchart illustrating a process for registering a UDC with a distributed digital content registry system and delivering an associated item in accordance with one embodiment.

FIG. 9 is a flowchart illustrating a process for obtaining an item associated with a UDC in a distributed digital content registry system in accordance with one embodiment.

### DETAILED DESCRIPTION

The detailed description that follows is represented largely in terms of processes and symbolic representations of operations by conventional computer components, including a processor, memory storage devices for the processor, connected display devices, and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

The terms “client appliance” and “server appliance” as used herein refer to software running on publishing host and client devices that enable the devices and hosts to communicate via distributed metadata network protocols.

One approach to solving these problems is by taking an open, top-down approach and developing a object-oriented database architecture that defines how all types of digital content will be classified, organized, found and delivered—in a manner that is distributed, extensible, and scalable. Upon this object-oriented database (sometimes called a content registry) is built an object-oriented platform, which allows a provider to execute semantic processes that allow it to generate a meaningful experience for the end user. Such an approach may be useful to numerous constituencies, including retailers, content owners, and individuals.

Described below is a content metadata system employing a content metadata registry to capture metadata around content, devices, rules, and consumers. In one embodiment, the content metadata registry includes an object-oriented database which creates associations around rules.

One embodiment is a solution for content retailers managing the distribution of their content offers in which the server appliance (the retailer's system) communicates to various client appliances, including services, distribution partners, advertising networks, community applications, viral applications, content recommendation, content gifting, content shifting, affiliate networks, advertising, locker, storage, and warranty to name a few. The server appliance may transmit information regarding the content and the business rules which can include rights of use, territory terms, compatibility, etc. The server appliance may further manage on behalf of a retailer access to their catalog information for various applications and distributors, communicates content information across disparate systems, tracks transaction and delivery of content at the consumer level and delivers business intelligence.

Another embodiment is a server appliance for content suppliers which is a rules based system dynamically mapping content, device, and consumer information interoperability and compatibility and enforcing content supplier and distributor's rules on rights of use. It communicates to various client applications and controls the distribution and consumption of content, protects and manages usage rights, tracks content across the value chain and client appliances, creates and delivers business intelligence and actionable data for targeting and marketing analytics.

In such an embodiment, the server appliance may integrate with existing content management systems and services, and it may automate content catalog information communication between the server appliance, the registry, and client appliances that have been approved by the content supplier. Such a system may also offer some or all of the following functionality:
(1) Dynamically associate compatibility and interoperability and enhance content catalog information.
(2) Create a unique content product identifier (UDC) for each product.
(3) Locate and map where content is warehoused and how it is delivered.
(4) Dynamically manage on behalf of the content supplier access to their catalog information for various applications and distributors.
(5) Communicate content information across disparate systems.
(6) Track transaction and delivery of content at the consumer level.
(7) Issue a purchase receipt of content information to the consumer's content locker for future use/warranty.
(8) Deliver business intelligence.

Another embodiment is a server appliance for a user for managing his or her music, videos, and images from a personal computer or other device as a publishing host using a server appliance to distribute and provide access to their content and the rules associated with the content to various individuals, applications, services. For example, a user may have a video in which he/she would like to post to various services, including social networking sites, social dating sites, video networks and to his digital home, which may include one or more personal computers, portable media devices, and audio/visual equipment. Each such service could have a client appliance in which they would register to access, display and use the video according to the user's policies.

Content Metadata Registry: metadata in the content metadata registry provides for both the technical documentation of data and the business rules associated with the content. The content metadata registry leverages a classification system that formally defines the hierarchies and relationships between different attributes, creating a system of classification that makes it very easy for the platform to scale quickly by adding new content types, rules and or devices and consumer information.

Furthermore, the content metadata registry has an association database that stores, finds, interprets, combines and acts on information for multiple content items, devices, and their associations. It also allows creation of new associations that can generate new content offerings/bundles.

The object-oriented platform allows building and querying of the object-oriented database from large amount of content and devices and connects that information with data in other non-interoperable information repositories. Using it, the system may be able to find, interpret, combine and act on information from multiple sources through structured sets of information and inference rules that allow it to ‘understand’ the relationship between different data resources and make logical connections. Further, semantic processes enable the system to process, transform, assemble and even act on the data in useful ways.

Whenever organizing any set of objects, one may use the object-oriented model, whereby any two objects are typically related through an association. This modeling usually takes the form of <object> <association> <object>. For example: <Ringtone> <is a kind of <audio file>. <Midi 4> <is a format of> <audio file>. These kinds of associations allow one to infer other kinds of associations. For example, from the above two associations, the system can infer: <midi 4> <is a format of > <Ringtone>.

This kind of association and inference mechanism provides the basis to organize, classify, infer from and act upon a variety of data once the data itself stored them in the object-oriented database.

One example assimilation process is followed across all varieties of objects such that the objects are organized in the system using a classification system that may be used to create associations between different objects. These associations then result in inferences that can be drawn to drive the other semantic processes.

In this process of providing the seamless experience across discovery mechanisms, digital good types, delivery mechanism and end devices, a basis for an approach is assimilation and organization of the digital content. The general organization process classifies the digital content based on one or more hierarchical relationships representing typical associations such as, for example, ‘is’, ‘has’, ‘has many’, ‘is like’, ‘formatted as’, ‘similar to’, etc. These associations can apply to the type of the digital content, as well as to specific types of such digital content.

Similar to how digital content is organized, metadata about specific devices may also be assimilated and organized. However, with devices, the associations may be very different. The associations with use-devices are tied to the capabilities of the device itself, and can result in associations such as ‘supports’, ‘compatible with’, ‘has’, ‘capable of’ and ‘allows’. Such an organization tells the system what a device can support, its compatibilities, and its features.

These two data structures are then connected to each other through different processes of generating new semantic associations. These processes include:
(1) Content device mapping: Creates associations between existing contents and devices.
(2) Content adaptation: Creates associations between contents and devices in a manner that creates new content formats that can then be fed into the content device mapping system.
(3) Content correlation: creates associations between different pieces of contents.
(4) Device correlation: creates associations between different types of devices.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

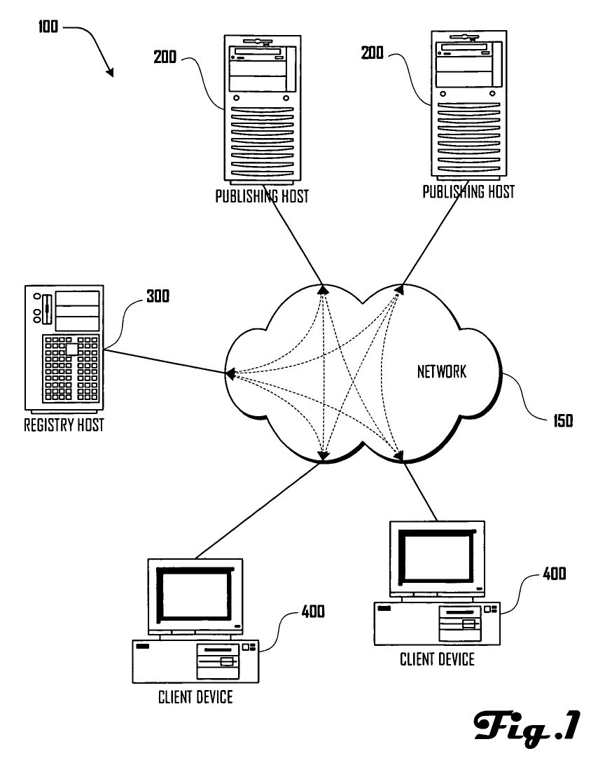

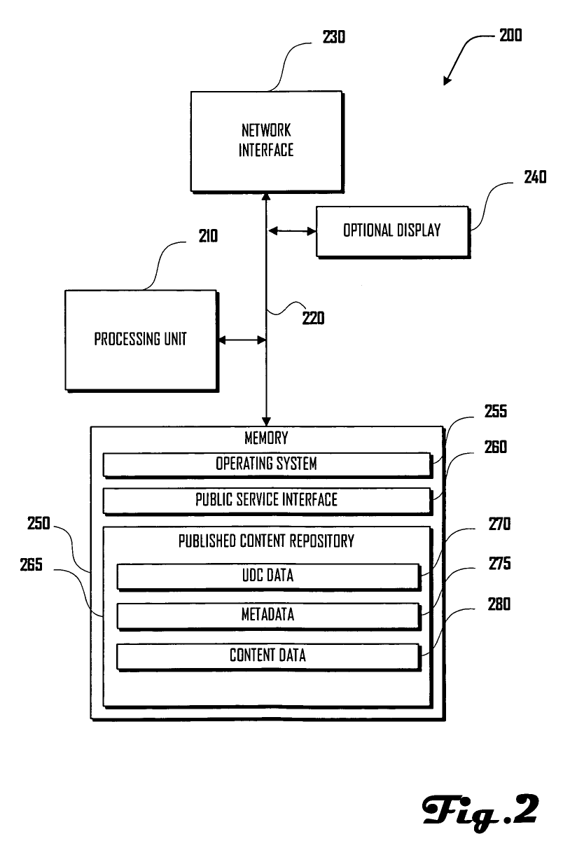

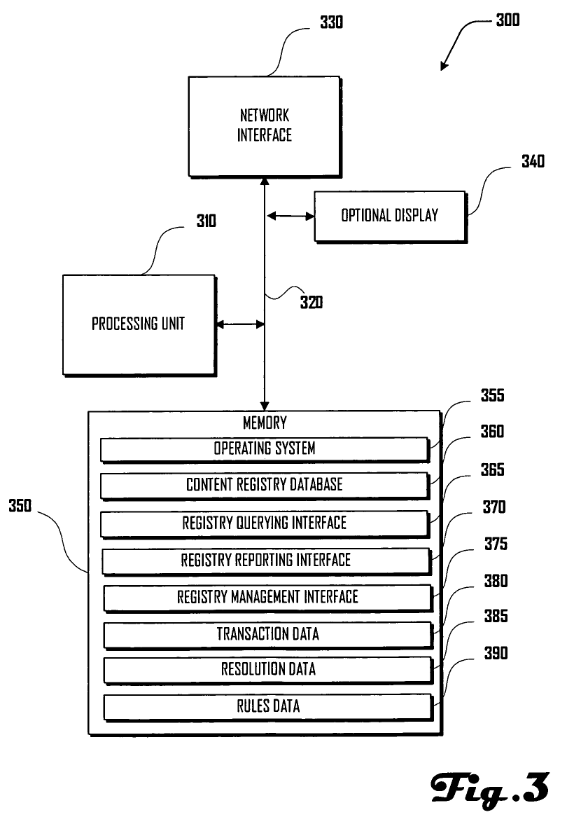

FIG. 1 illustrates an exemplary distributed digital content registry system 100 having a number of devices used in exemplary embodiments. FIG. 1 illustrates a content registry host 300, illustrated in FIG. 3 and described below, connected to one or more Publishing Hosts 200, illustrated in FIG. 2 and described below, a network 150 (such as a local or wide area network, e.g., the Internet or the like) and a number of client devices 400, illustrated in FIG. 3 and described below. A client device 400, publishing host 200, and registry host 300 may include a personal computer, a portable media playback device, a mobile phone, and the like. The various components communicate via the network as described in detail below. In general, a registry host 300 serves as an intermediary to allow a client/consumer 400 to identify and connect to a publisher/seller 200.

In further embodiments, still additional devices (not shown) may be utilized in the distributed digital content registry system 100. Likewise, in some embodiments, other devices (both shown and not shown) may be combined. For example, the Publishing Host 200 and content registry 300 may be in the same device. In some embodiments, a Publishing Host 200 may also act as a client device 110, and visa versa. In one embodiment, a single device may act as client, publisher, and registry. But in an exemplary embodiment, the content registry host 300, publishing host 200, and client device 400 are distinct devices. In an exemplary embodiment, the registry host 300 creates a peer-to-peer market between a publishing host 200 and client device 400.

The mechanics underlying a distributed digital content registry system 100 could be implemented by various techniques. One of the techniques is to use open standard protocols and lightweight registries, which can help in critical functions like routing of requests, enforcing global rules and policies, registration of nodes etc. This implementation could be built upon using open standards like XML, web services etc. There can be service APIs which can be used to access such nodes by client devices 400 and publishing hosts 200.

Yet another implementation could be built using an enhanced version of the basic Handle system, which is a distributed digital object architecture. However, the basic Handle architecture would likely need several enhancements to properly implement a distributed digital content registry system 100 as described herein. Such enhancements may include the following:
(1) Map the existing functionality into a modern transport protocol (e.g., SOAP).
(2) Extend the attribute semantics to support string names rather than just integer IDs.
(3) Enhance the security model (e.g., authentication and authorization).
(4) Define a standard for extending Handle Server implementations to support dynamic scenarios (i.e., extend Handle in a manner analogous to the manner in which Common Gateway Interface (CGI) extended Hypertext Transfer Protocol (HTTP)).

FIG. 2 illustrates several components of the Publishing Host 200. In some embodiments, the Publishing Host 200 may include many more components than those shown in FIG. 2. However, it is not necessary that all of these generally conventional components be shown in order to disclose an illustrative embodiment. As shown in FIG. 2, the Publishing Host 200 includes a network interface 230 for connecting to other devices in the distributed digital content registry system 100. In various embodiments, the network interface 230 includes the necessary circuitry for such a connection and is constructed for use with the appropriate protocol.

The Publishing Host 200 also includes a processing unit 210, a memory 250 and may include a display 240, all interconnected along with the network interface 230 via a bus 220. The memory 250 generally comprises a random access memory (“RAM”), a read only memory (“ROM”), and a permanent mass storage device, such as a disk drive. The memory 250 stores the program code necessary for a public service interface 260 and a published content repository 265, which includes published UDC data 270, metadata 275, and content data 280. In addition, the memory 250 also stores an operating system 255. It will be appreciated that these software components may be loaded from a computer readable medium into memory 250 of the Publishing Host 200 using a drive mechanism (not shown) associated with a computer readable medium, such as a floppy disc, tape, DVD/CD-ROM drive or via the network interface 230.

Much like a web server exposes (publishes) content to web clients via a standardized interface, the public service interface 260 enables the Publishing Host 200 to expose metadata to clients 400 in a distributed digital content registry system 100. In exemplary embodiments, the public service interface 260 is implemented as a software application, daemon, or service.

Although an exemplary Publishing Host 200 has been described that generally conforms to conventional general purpose computing devices, those of ordinary skill in the art will appreciate that a Publishing Host 200 may be any of a great number of devices capable of communicating with the device within the distributed digital content registry system 100.

FIG. 3 illustrates several of the key components of the content registry 300. In some embodiments, the content registry 300 may include many more components than those shown in FIG. 3. However, it is not necessary that all of these generally conventional components be shown in order to disclose an illustrative embodiment. As shown in FIG. 3, the content registry 300 includes a network interface 330 for connecting to other devices in the digital content registry system 100. In various embodiments, the network interface 330 includes the necessary circuitry for such a connection and is constructed for use with the appropriate protocol.

The content registry 300 also includes a processing unit 310, a memory 350 and may include a display 340, all interconnected along with the network interface 330 via a bus 320. The memory 350 generally comprises a RAM, a ROM, and a permanent mass storage device, such as a disk drive. The memory 350 stores the program code necessary for a content registry database 360, registry querying routine 365, a registry reporting routine 370, a registry management interface 375, a transaction data 380, resolution data 385, and rules data 390. In addition, the memory 350 also stores an operating system 355. It will be appreciated that these software components may be loaded from a computer readable medium into memory 350 of the content registry 300 using a drive mechanism (not shown) associated with a computer readable medium, such as a floppy disc, tape, DVD/CD-ROM drive or via the network interface 330.

A publishing host 200 may utilize the registry management interface 375 for registering as a content publisher, registering new UDC entries, editing/deleting existing UDC entries, and the like. In one embodiment, registering as a content publisher involves adding publishing host 200 information to a table or database of resolution data 385 that may enable the registry host 300 to locate or identify the publishing host 200 to client devices 400. In some embodiments, the publishing host may also utilize an internal or external automated ingestion system to facilitate the creation of new UDC entries. Such an ingestion process may include some or all of the following steps: validation, normalizing metadata, creating semantic associations, transcoding content, and generating an identifier. The ingestion process may thus act to maintain consistency while also accommodating the receipt of metadata in a wide array of formats.

Although an exemplary content registry 300 has been described that generally conforms to conventional general purpose computing devices, those of ordinary skill in the art will appreciate that a content registry 300 may be any of a great number of devices capable of communicating with the device within the digital content registry system 100. In some embodiments, a publishing host 200 or a client device 400 may act also as a registry host 300.

Within the context of the content registry, all stored data may have layers of associations such that specific associations may be inherited and maintained (similar to object-oriented programming object inheritance). In this manner, metadata in the digital registry may maintain specific associations, e.g., a Rolling Stones ringtone as provided by Sony as opposed to any non-descript Rolling Stones ringtone. Furthermore, additional layers of association may be maintained and inherited, e.g., a Rolling Stones ringtone provided by Sony and formatted to be compatible with a Sprint mobile phone.

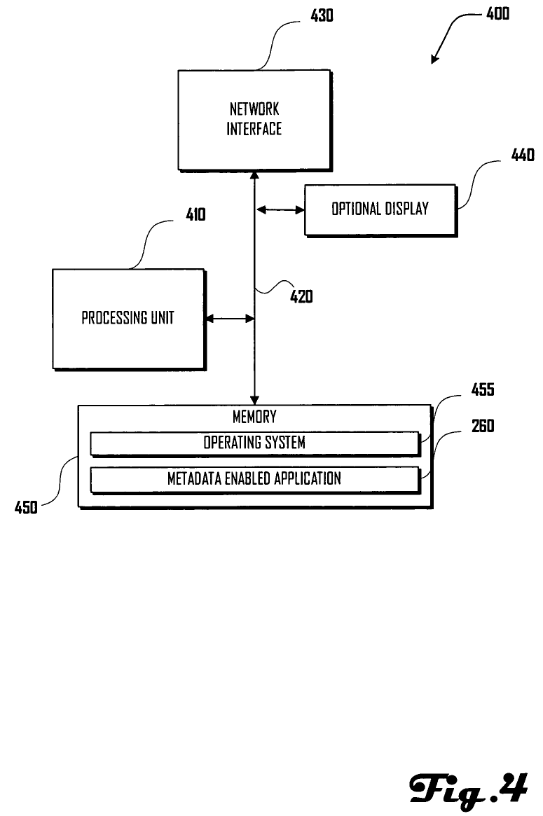

FIG. 4 illustrates several components of the client device 400. In some embodiments, the client device 400 may include many more components than those shown in FIG. 4. However, it is not necessary that all of these generally conventional components be shown in order to disclose an illustrative embodiment. As shown in FIG. 4, the client device 400 includes a network interface 430 for connecting to other devices in the distributed digital content registry system 100. In various embodiments, the network interface 430 includes the necessary circuitry for such a connection and is constructed for use with the appropriate protocol.

The client device 400 also includes a processing unit 410, a memory 450 and may include a display 440, all interconnected along with the network interface 430 via a bus 420. The memory 450 generally comprises a random access memory (“RAM”), a read only memory (“ROM”), and a permanent mass storage device, such as a disk drive. The memory 450 stores the program code necessary for a metadata enabled application 460. Such an application 460 may make use of a standard protocol to enable access to published content and metadata via communications with a registry host 300 and a publishing host 200.

In addition, the memory 450 also stores an operating system 455. It will be appreciated that these software components may be loaded from a computer readable medium into memory 450 of the client device 400 using a drive mechanism (not shown) associated with a computer readable medium, such as a floppy disc, tape, DVD/CD-ROM drive or via the network interface 430.

Although an exemplary client device 400 has been described that generally conforms to conventional general purpose computing devices, those of ordinary skill in the art will appreciate that a client device 400 may be any of a great number of devices, including portable media players, mobile phones, and the like, capable of communicating with the components of the distributed digital content registry system 100.

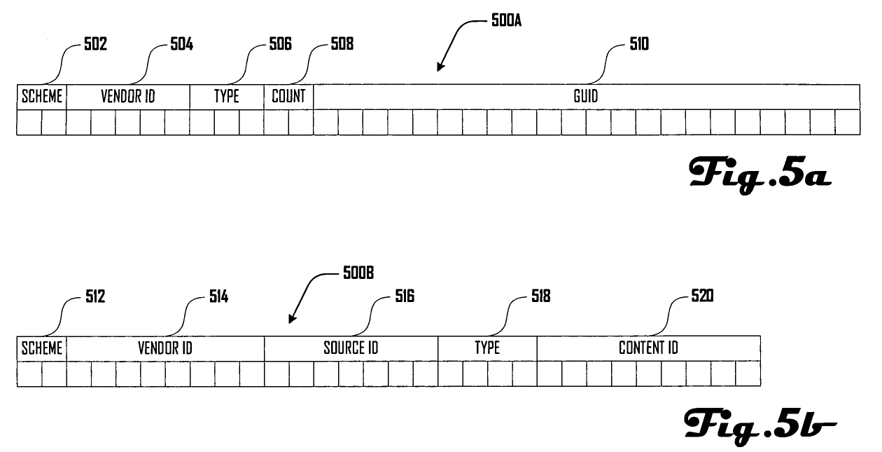

FIG. 5a illustrates examples of an uncompressed UDC 500A and may include a Scheme 502, VendorID 504, media type 506, Counter 508 and GUID 510.

Scheme 502—Some codes in the scheme digits may be reserved, but most are open to interpretation by vendors.

VendorID 504 is a code which will be assigned by the registry, similar to a unique email userid used by existing email systems. In some embodiments, a CAE code or IPI (interested parties information) number may be used for a VendorID.

Media type 506 is defined by the registry host 300 for standard media types, but publishers may register new types. The list will be made public.

Counter 508 may be assigned and maintained by a vendor or publisher to distinguish items derived from the same content.

GUID 510—In one embodiment, Base64 encoded GUID identifies the source of the media type. In some embodiments an International Standard Recording Code (ISRC), International Standard Musical Work Code (ISWC) or Global Release Identifier (GRid) may be used instead of a generated GUID.

This scheme allows a 34 digit code allowing primary source traceability and report reconciliation. With chaining for complete traceability, each link in the chain only adds 12 digits. For example: Level 1-34; Level 2-46; Level 3-58; Level 4-70; and so on.

For example if a content creator (e.g., “The Rolling Stones”) has content (e.g., the song “Start Me Up”) that is owned by a record label (e.g., “Virgin Benelux B.V.”) a particular version of the content (e.g., the version on the album “Tattoo You”) would be a good source piece of media content and probably the source version of derived versions of the media content (if not derived directly from a master version that was used to create the album version). Therefore using such a GUID UDC scheme would allow derivative versions of this UDC content to maintain a similar UDC, namely using the same GUID.

For example a UDC of an MP3 created from the source of “Start Me Up” might look like: 12-000A0-Bx5-05-7QDBkvCA1+B9K/U0vrQx1A. The respective fields in the UDC separated by dashes would be in their respective order indicator for a scheme, vendor, media type, counter and of course the GUID. A scheme may indicate how the UDC was created and for what purpose, e.g. a vendor-created UDC. The vendor (e.g., Virgin Benelux BV) meanwhile would be an identifier of the entity providing the content identified by the UDC to consumers (or possibly other vendors). The media type would describe the format of the content (e.g., an MP3 sampled at 320 bps). The counter allows for different versions of similarly schemed, vended and media typed content, for example, in the song “Start Me Up” a vendor that has created a ringtone may create multiple ringtones from different parts of the song. The counter would allow for a differentiation between the separate ringtone. In one embodiment a UDC created by the vendor would increment from the bottom and a UDC created by a registry would decrement from the back so as to allow each to create separate versions of UDCs with a minimal chance of a “collision”. Finally, the GUID is a globally unique identifier that is unlikely to have a chance for a collision. In general, a GUID may be 128 bit pseudo-randomly generated number that, while not guaranteed to be unique, has such a large number of unique keys that the probability of the same number being generated twice is very small. It may be beneficial to have UDCs that are relatively short and yet still represented via conventional characters, accordingly a “base64” encoding of the GUID allows it to be encoded as a string of 22 characters and still represent all 128 bits.

The UDC could be used as a common source UDC or could be chained with additional scheme/vendor/media type/counter data to create chained UDCs that trace the vending of the UDC from one vendor to the next. For example, if Virgin Benelux provides the “Start Me Up” content to Cingular wireless as a ringtone, the UDC may have additional scheme/vendor/media type/counter data included. For example:

12-000A0-Bx5-05-7QDBkvCA1+B9K/U0vrQx 1A-12-011Bm-Bx5-01.

This would show that the Virgin Benelux content was licensed to Cingular wireless such that when it was vended to consumers the content was traceable back to Virgin Benelux.

In some embodiments, various compression algorithms may be used. However, compression would produce a Uniform Compressed Code (“UCC”), and it might not be attractive to the participants as the GUID would no longer be the same amongst similarly sourced pieces of content.

Also, the tracing can be represented in a registry or other database. Each record of derived version of the content may “point” back or otherwise refer to the version of the content that it was derived from. This would allow for the dynamic generation of UDCs from the relationships between versions to the content. Other versions may include:

Following are in one exemplary alternate embodiment the UDC may be formed of all hex digits (0-9A-F).

One alternate embodiment allows for compressed forms of UDCs. For example a UCC (Unified Compressed Code). The UCC would be passed from one point to another. UCC would allow chained information of UDCs. In one embodiment a UCC will be formed by UDC compression using a publicly available or a proprietary, compression standard.

In one example:

UDC 1=11-ABCD1234-2345-2345CDEF

UDC 2=11-11223344-2345-12344321

UDC 3=12-12345234-2345-1234ABCD

Suppose, UDC1 is created by Vendor 1, derived by Vendor 2, which is further derived by Vendor 3

Compression would proceed as follows:

UCC 1=424235363463634637745408583450985390583059 and is created by compressing UDC 2 and UDC 1 (11-11223344-2345-12344321, 11-ABCD1234-2345-2345CDEF).

UCC 2=1221313213123213133131313121321313123 and is created by compressing UDC 3 and UCC1 (12-12345234-2345-1234ABCD, 424235363463634637745408583450985390583059).

Decompression would proceed as follows

UCC 2=1221313213123213133131313121321313123

Decompress once provides UDC3 (12-12345234-2345-1234ABCD) and UCC1 (424235363463634637745408583450985390583059)

Decompress twice provides UDC2 (11-11223344-2345-12344321) and UDC1 (11-ABCD1234-2345-2345CDEF)

Such an embodiment can handle chains of UDCs.

Under similar logic, it is possible to modify the UDC 500B to be 15 bytes (30 slots) as illustrated in FIG. 5b. In FIG. 5b the UDC includes: Scheme 512, Vendor ID 514, Source ID 516, Media Type 518 and Content ID 520. By including a Vendor ID 514 and Source ID 516 it is possible to “traverse” the registry by the providing source and determine the relationships between various content providers much like a bidirectional linked list in a computer software program. This will help in tracking resellers without requiring a check of a registry.

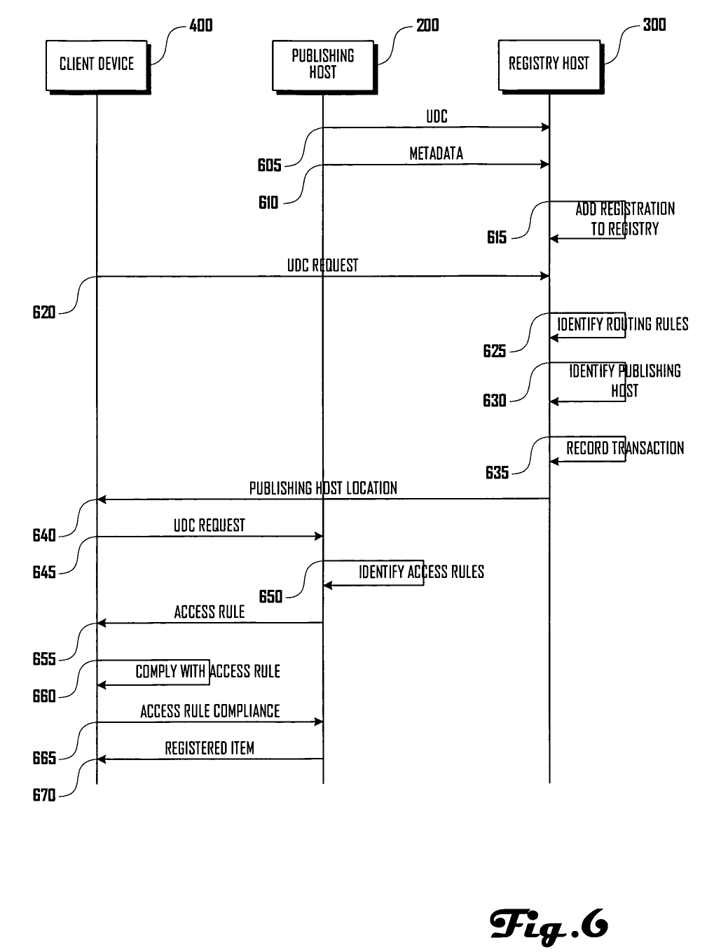

FIG. 6 illustrates the actions taken by devices in a distributed content registry system for registering metadata and delivering content in accordance with one embodiment. A publishing host 200 may wish to expose metadata and/or publish content using a digital content registry system 100 according to one or more explicit or implicit rules. For example, in one embodiment, an individual computer user may wish to expose to friends and acquaintances personal information such as his or her name and contact information. In another embodiment, an amateur creator may with to expose a music or video file that he or she created, but only to free sharing sites, such as YouTube or Yahoo! Video, and not for resale. In yet another embodiment, a professional musician may wish to publish a new audio track for sale directly to his or her fans at a certain price with specified usage conditions. In a further embodiment, a seller may wish to expose metadata (e.g., name, description, price, and the like) concerning physical goods that are offered for sale. In a final exemplary embodiment, a commercial content reseller may with to publish a catalog of media files for sale to the general public and to allow purchased files to by synched with a particular type of portable media player.

The publisher 200 obtains a UDC (in compressed or uncompressed form) associated with the content or item to be exposed. Such a UDC may be obtained in any number of ways, including by interacting with a registry host 300, utilizing an automated ingestion system, self-assignment, or other method. The publisher 200 sends the UDC 605 to a registry host 300. The publisher also sends metadata 610 associated with the content and the UDC. Metadata may have been generated as part of the UDC creation process, and it may have been automatically or manually normalized and/or placed into a standard format (e.g., Extensible Markup Language (“XML”), flat file, delimited text, spreadsheet, and the like). The metadata may include information such as an identification of the publishing host 200 (e.g., a hostname and/or IP address), access rules (e.g., only available to U.S. consumers, usage restrictions, DRM restrictions, transcoding or format restriction, a price, and the like), a name and/or description of the content, the origin of the content (e.g., created by a particular artist or from a particular company), and a delivery channel (e.g., the content may be downloaded across a particular mobile phone operator's network). In some embodiments, some or all such metadata may be incorporated into the UDC. The registry host 300 registers 615 the UDC and some or all of the metadata into a content registry.

A client device 400 discovers a UDC representing content or an item that is of interest and sends a UDC request 620 to the registry host 300. The discovery process may take place in any number of ways. For example, in various embodiments, a user may discover a UDC from a website storefront, from a recommendation service, from an advertisement, or by any other method. The registry host 300 identifies one or more routing rules 625. Routing rules may be stored in rules data 390 and may enable the registry host 300 to locate the appropriate publishing host 200, based on information contained within the UDC. For example, in one embodiment, a UDC may comprise a host identifier within a hierarchical or tree host space, which may be analogous to the domain name space tree utilized by the Domain Name System (DNS) that translates hostnames into IP addresses on the Internet.

Routing rules may also include exceptions. For example, the registry host 300 may maintain, as part of the rules data 390, a list of clients 400 that submit invalid UDCs and may block requests from those clients accordingly. If no rules are violated, the registry host 300 identifies 630 the publishing host 200 associated with the requested UDC. In one embodiment, identifying 630 the publishing host 200 involves looking up the host 200 in resolution data 385. In some embodiments, identifying 630 the publishing host 200 may involve querying another registry host 300.

In some embodiments, registry host 300 records 635 into transaction data 380 the current transaction (the client's “dip” into the registry 100). Such transaction data 380 may be used for reporting purposes or for billing purposes. For example, in one embodiment, the registry host 300 may provide periodic transaction reporting to a publisher. In another embodiment, transaction data 380 may be used to bill a client and/or a publisher per each pertinent transaction or “dip” into the registry.

Registry host 300 sends the identified location 640 of the publishing host 200 that can provide the client 400 with the requested UDC. In various embodiments, the location data may include a hostname, IP address, and/or the location of another registry host that may be able to direct client 400 to the appropriate publishing host 200. Client device 400 uses the received location information to send a UDC request 645 to publishing host 200. Publishing host consults the UDC data 270 and metadata 275 that are stored in the content repository 265 to identify 650 one or more access rules. The access rules or conditions must generally be met before publishing host 200 will supply client 400 with the requested data. For example, in one embodiment, client 400 must pay an indicated amount to publisher 200 before being allowed access to the content or item associated with the requested UDC. In another embodiment, publisher 200 may verify the geographical location of the client 400 in accordance with a geographical use restriction access rule. Publishing host 200 sends the rule(s) or condition(s) 655 to client 400. Client 400 complies with the rules 660 and notifies publishing host 200. In some embodiments, publishing host takes a further step of verifying compliance. Once the rule is met, publishing host 200 delivers 670 to client 400 the content or item associated with the requested UDC. In one embodiment, delivering the content or item may involve directing the client to another publishing host 200.

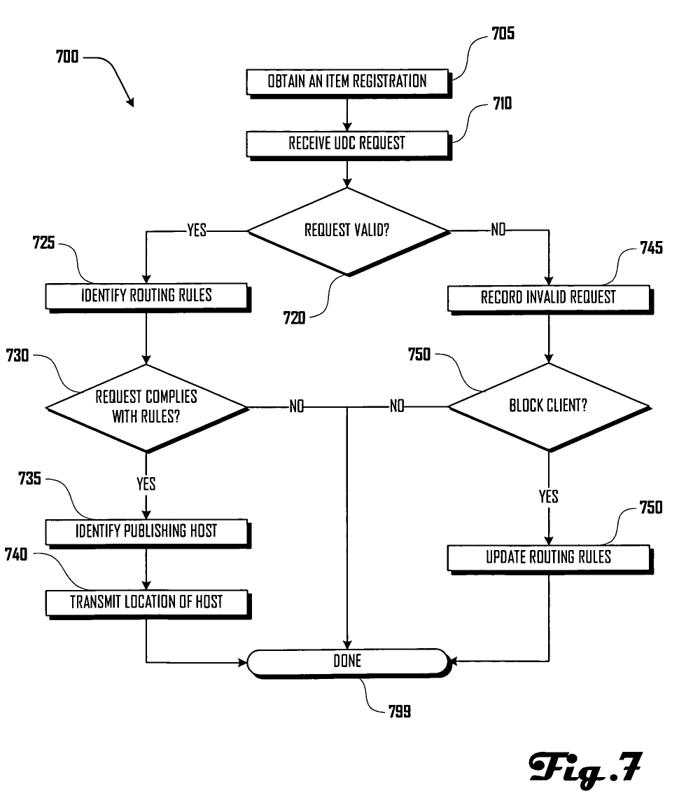

FIG. 7 illustrates a process for receiving a UDC registration in a distributed content registry system 100 and servicing a UDC request in accordance with one embodiment. In an exemplary embodiment, the steps of this process are executed on a device acting as a registry host 300. In various embodiments, the same device may also act as a publishing host 200 and/or a client device 400. In step 705, a registration for a item or content is obtained. Such registration includes obtaining, deriving, assigning, and/or requesting a UDC associated with the item or content. Such registration also includes obtaining metadata associated with the UDC. The registration information is recorded into a content registry 360. In step 710, a request for a particular UDC is received via a registry querying interface 365. In step 715 the UDC request is validated to ensure, for example, that the UDC is properly formed. If not, the invalid request is recorded in step 745. In step 750, the client that submitted the bad request is evaluated, and if the client is determined to be submitting too many bad requests, routing rules data 390 may be updated in step 750.

If the UDC request is valid, pertinent routing rules (if any) are identified (from routing rules data 390) in step 725, and the request evaluated in step 730. If the request complies with the routing rules, in step 735, a pertinent publishing host 200 is identified from the content registry 360. In step 740, this location is transmitted to the requesting client.

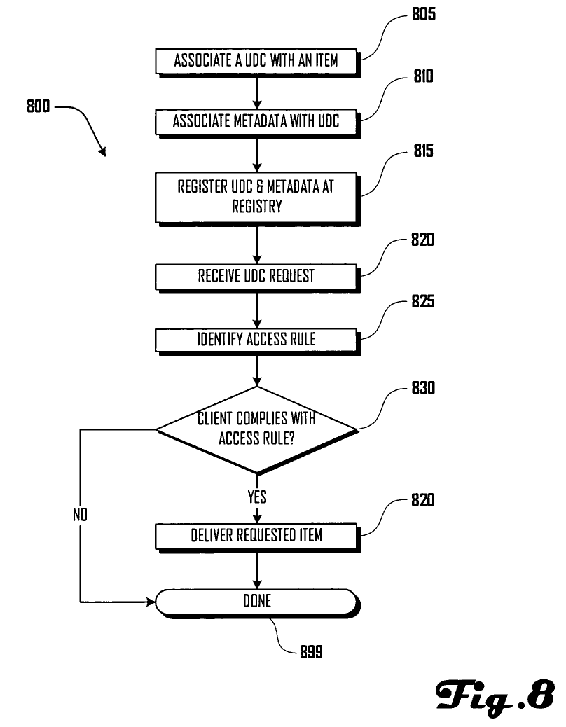

FIG. 8 illustrates a process for registering a UDC with a distributed content registry system 100 and delivering an associated item or content in accordance with one embodiment. In step 805, a UDC is associated with an item, which may include a physical or a digital (content) good. In step 810, metadata (discussed above) is associated with the UDC, and in step 815, the UDC and metadata are registered with a distributed content registry 100 so that clients 400 who desire to obtain the item will be able to locate the item via the registry 100. In step 820, a request is received from such a client 400. In step 825, an access rule, (if any) corresponding to the requested UDC is identified. In one embodiment, an access rule may be identified via a content repository 265. In another embodiment, an access rule may be encoded into the UDC.

In step 830, verification is obtained that the requesting client 400 has complied with all applicable access rules. Some UDCs may be associated with multiple access rules. Other UDCs may be associated with no access rules, thus ensuring that the associated item will be delivered to each requesting client. In step 820, the requested item is delivered to the client 400. The actual form of delivery depends on the type of item requested. In some embodiments, delivery may comprise transmitting data to client 400 across a network. In other embodiments, delivery may comprise shipping a physical good.

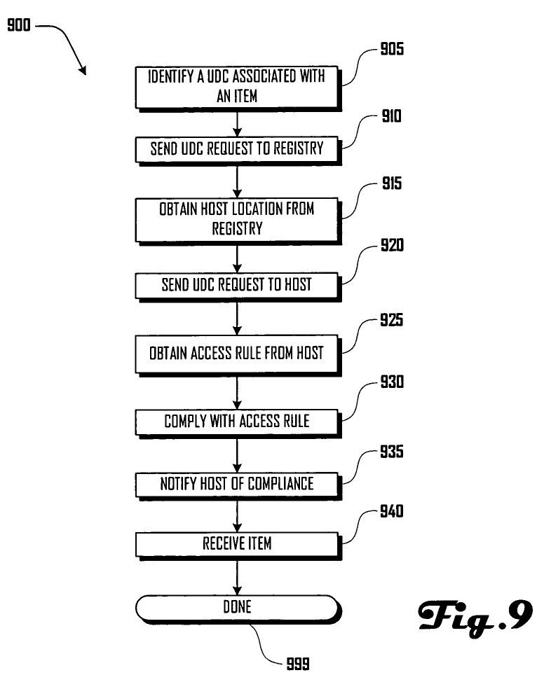

FIG. 9 illustrates a process for obtaining an item associated with a UDC in a distributed content registry system in accordance with one embodiment. In step 905, a UDC associated with a desired item is identified or “discovered.” This discovery process is discussed above in reference to FIG. 6. In step 910, a UDC request is sent to a distributed content registry system 100. In step 915, the location of a publishing host 200 associated with the UDC is returned by the registry 100. The interactions between a client 400 and a registry host 300 are discussed above in reference to FIGS. 6 and 7. Using the obtained location, in step 920, a UDC request is sent to the identified publishing host 200. In step 925, an access rule is obtained from the host 200, and in step 930, the access rule is complied with. After notifying the host 200 of compliance in step 935, the requested item is received in step 940.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. This application is intended to cover any adaptations or variations of the embodiments discussed herein.

1. A computer-implemented registry comprising:
a plurality of registrations, wherein each registration:
is associated with an item, and
comprises:
a Universal Digital Code (UDC); and
metadata comprising a host, an access rule, and at least one of a name, an origin, and a delivery channel;
a plurality of transaction records, each associated with at least one of said plurality of registrations;
a plurality of routing rules, operative at least to identify in accordance with said metadata a plurality of hosts respectively associated with said plurality of registrations; and
a public service interface operative at least to:
obtain a registration from a publisher, and
route a UDC request from a client to a selected one of said plurality of hosts in accordance with said plurality of routing rules.

2. The registry of claim 1, wherein said item comprises at least one of digital content and physical product.

3. The registry of claim 1, wherein said UDC comprises a globally unique identifier operative to associate derivative versions of said item.

4. The registry of claim 3, wherein said UDC further comprises at least one of counter data operative to identify a derivative version of said item, scheme, vendor, and media type.

5. A method of mediating a marketplace via a registry host, the method comprising:
obtaining from a publisher a registration associated with an item, the registration comprising:
a Universal Digital Code (UDC); and
metadata comprising a host, an access rule, and at least one of a name, an origin, and a delivery channel;
receiving a request for said UDC from a client seeking information associated with said item;
identifying a plurality of routing rules in accordance with said metadata;
identifying a host associated with said UDC in accordance with said plurality of routing rules;
recording the registry transaction; and
transmitting a location of said host to said client in accordance with said plurality of routing rules.

6. The method of claim 5, wherein said item comprises at least one of digital content and physical product.

7. The method of claim 5, wherein said UDC comprises a globally unique identifier operative to associate derivative versions of said item.

8. The method of claim 7, wherein said UDC further comprises at least one of counter data operative to identify a derivative version of said item, scheme, vendor, and media type.

9. The method of claim 5, wherein said access rule comprises at least one of a valuation, a use restriction, a DRM system restriction, a geographical restriction, a transcoding restriction.

10. A method of publishing an item via a publishing host, the method comprising:
associating a Universal Digital Code (UDC) with an item;
associating with said UDC metadata comprising said host, an access rule, and at least one of a name, an origin, and a delivery channel;
registering said UDC and said metadata via a registry;
receiving a request for said UDC from a client via a public service interface, the client having been routed to said host via said registry;
delivering said item in accordance with said access rule.

11. The method of claim 10, wherein said item comprises at least one of digital content and physical product.

12. The method of claim 10, wherein said UDC comprises a globally unique identifier operative to associate derivative versions of said item.

13. The method of claim 12, wherein said UDC further comprises at least one of counter data operative to identify a derivative version of said item, scheme, vendor, and media type.

14. The method of claim 10, wherein said client is a process executing on said publishing host.

15. The method of claim 10, wherein said registry is hosted on said publishing host.

16. The method of claim 10, wherein said registry is hosted on a remote host.

17. The method of claim 10, further comprising authorizing said client.

18. The method of claim 10, further comprising obtaining payment for said item.

19. The method of claim 10, further comprising verifying a location of said client.

20. A method of obtaining an item at a client, the method comprising:
identifying a Universal Digital Code (UDC) associated with a registered item;
obtaining from a registry a location of a host associated with said UDC;
obtaining from said host a rule associated with said UDC;
complying with said rule; and
obtaining said registered item.

21. The method of claim 20, wherein said item comprises at least one of digital content and physical product.

22. The method of claim 20, wherein said UDC comprises a globally unique identifier operative to associate derivative versions of said item.

23. The method of claim 20, wherein said UDC further comprises at least one of counter data operative to identify a derivative version of said item, scheme, vendor, and media type.

24. The method of claim 20, wherein complying with said rule comprises making a payment.
